(19) United States
(12) Patent Application Publication
(10) Pub. No.: US 2008/0155112 A1
(43) Pub. Date: Jun. 26, 2008

(54) SYSTEM AND METHOD FOR UPDATING INFORMATION FEEDS

(75) Inventors: Jian Ma, Beijing (CN); Kuifei Yu, Beijing (CN)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/615,251

(22) Filed: Dec. 22, 2006

(51) Int. Cl. G06F 15/16

(52) U.S. Cl. 709/231

(57) ABSTRACT

Systems and methods for transmitting and updating information feeds from a server to a client are provided to increase bandwidth efficiency and improve the timeliness of information feed updates. Using OMA DS protocols, the updating of RSS feeds, for example, may be performed without having to transfer an entire RSS feed. That is, in some arrangements, only the new RSS items are synchronized with a client. A server may alert the client when a new RSS item has been added to an RSS feed. A synchronization session may then be initialized between the server and the client. A client may send a synchronization alert to the server identifying the feed or feeds for which synchronization is desired. The server may respond with one or more new items corresponding to the identified feeds. RSS item identification information may further be mapped between the client and the server.

### FIELD OF ART

The invention relates generally to a method and system for transferring and updating information feeds.

### BACKGROUND

Really Simple Syndication or Rich Site Summary (RSS) format has become increasingly popular as a means for obtaining information from the Internet. RSS feeds allow users to find or construct a channel of information that is directly relevant to their interests. Updates to the RSS feeds (e.g., updated news articles or other content) may be provided to subscribing users by transmitting the entire RSS feed to the user's device. Generally, the user's device will parse the newly received RSS feed to identify the new items. The use of RSS aggregator applications allows automatic monitoring of RSS feeds for new content. As such, a user does not have to manually access websites to determine if new content is available.

Current methods of transmitting new RSS content consume significant bandwidth as entire RSS feeds must be transmitted to a user's device. That is, old RSS items that already exist on a user's device are transmitted along with new RSS items. In addition, RSS aggregators typically only check (i.e., poll) for new RSS items according to a predefined schedule. As such, new items might not be received by the user in a timely manner. Furthermore, periodic polling of RSS servers may cause a user to unnecessarily incur network access costs for polling RSS servers when new items are not available.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

By using a synchronization protocol to update RSS feeds in a client device or system, bandwidth efficiency and update timeliness may be improved. According to one aspect, RSS feeds may be synchronized according to an Open Mobile Alliance (OMA)-data synchronization (DS) protocol also known as SyncML. OMA-DS (i.e., SyncML) provides a channel update alert to a client when new items are available in a feed to which the client is subscribed. The client may initialize a synchronization session with the server. Once the synchronization session is initialized, the client may issue a synchronization alert to the server identifying one or more feeds for which updating/synchronization is desired. In response, the server may retrieve new items from an item database for the specified feeds. The new items may then be packaged into a synchronization message and transmitted to the client. The synchronization message may include synchronization commands such as add, delete, replace and the like. The client may process the new items according to the commands and provide an update status to the server in the form of a data update status package. Communications between the server and the client, while structured according OMA-DS protocols, may further be encapsulated in a variety of transmission formats such as Hypertext Transfer Protocol (HTTP), object exchange (OBEX), e-mail and the like.

According to another aspect, clients may also add items to an RSS feed using an OMA-DS protocol. For example, a user of a client device may write an article pertinent to a topic associated with a particular RSS feed. To add the article to the RSS feed, the client device may initialize a synchronization session with an RSS server and transmit a synchronization package to the server. The synchronization package may include one or more new feed items as well as synchronization commands for execution by the server. The server may respond with a status package that indicates to the client whether the commands were performed successfully.

According to yet another aspect, data may be stored in the server using one or more tables. For example, user information, RSS item information and subscription information may each be stored in a separate table. Alternatively or additionally, the information may be stored in combination in a comprehensive data table. The use of tables may allow the server to more easily retrieve data.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a mobile terminal on which one or more aspects described herein may be implemented.

FIG. 2 illustrates a prior art system and process for updating RSS feeds.

FIG. 3 illustrates a system and process for synchronizing new items in an RSS feed between a server and a client according to one or more aspects described herein.

FIG. 4 is a flowchart illustrating a method by which a user may register for an RSS feed service according to one or more aspects described herein.

FIG. 5 is a flowchart illustrating an RSS feed subscription method according to one or more aspects described herein.

FIG. 6 illustrates a process diagram for detecting and synchronizing new items in an RSS feed according to one or more aspects described herein.

FIG. 7 illustrates a synchronization package structure according to one or more aspects described herein.

FIG. 8 illustrates an RSS item data structure according to one or more aspects described herein.

FIG. 9 is a flowchart illustrating a method for detecting and distributing new RSS items according to one or more aspects described herein.

FIG. 10 is a flowchart illustrating a method for updating a client RSS feed with new RSS items according to one or more aspects described herein.

FIG. 11 illustrates a process by which a client may add a new item to an RSS feed using synchronization protocols according to one or more aspects described herein.

FIG. 12 illustrates a block diagram of a synchronization server according to one or more aspects described herein.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

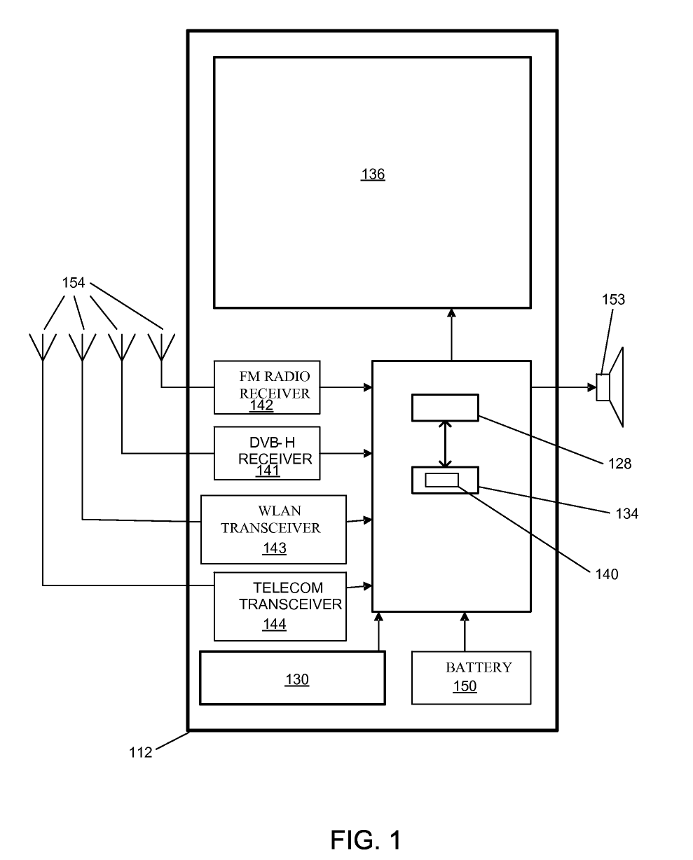

FIG. 1 illustrates a block diagram of a terminal including processor 128 connected to user interface 130, memory 134 and/or other storage, and display 136. Mobile terminal 112 may also include battery 150, speaker 153 and antennas 154. User interface 130 may further include a keypad, touch screen, voice interface, one or more arrow keys, joy-stick, data glove, mouse, roller ball, touch screen, or the like. Mobile terminal 112 may comprise a computer, personal data assistant (PDA), mobile telephone and the like.

Computer executable instructions and data used by processor 128 and other components within mobile terminal 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile terminal 112 to perform various functions. Alternatively, some or all of mobile device 112 computer executable instructions may be embodied in hardware or firmware (not shown).

Mobile terminal 112 may be configured to receive, decode and process digital broadband broadcast transmissions that are based, for example, on the DVB standard, through a specific DVB receiver 141. The mobile device may also be provided with other types of receivers for digital broadband broadcast transmissions. Additionally, mobile terminal 112 may also be configured to receive, decode and process transmissions through FM/AM Radio receiver 142, WLAN transceiver 143, and telecommunications transceiver 144. Transceivers 143 and 144 may, alternatively, be separated into individual transmitter and receiver components (not shown). In one aspect of the invention, mobile terminal 112 may receive Radio Data System (RDS) messages. Other transmission and reception systems may also be used including Bluetooth transceivers. In one or more instances, signals may be transmitted to and received from another mobile terminal (not shown). For example, audio, video and other signals may be transmitted between two terminals using various transmissions protocols (e.g., WLAN or Bluetooth).

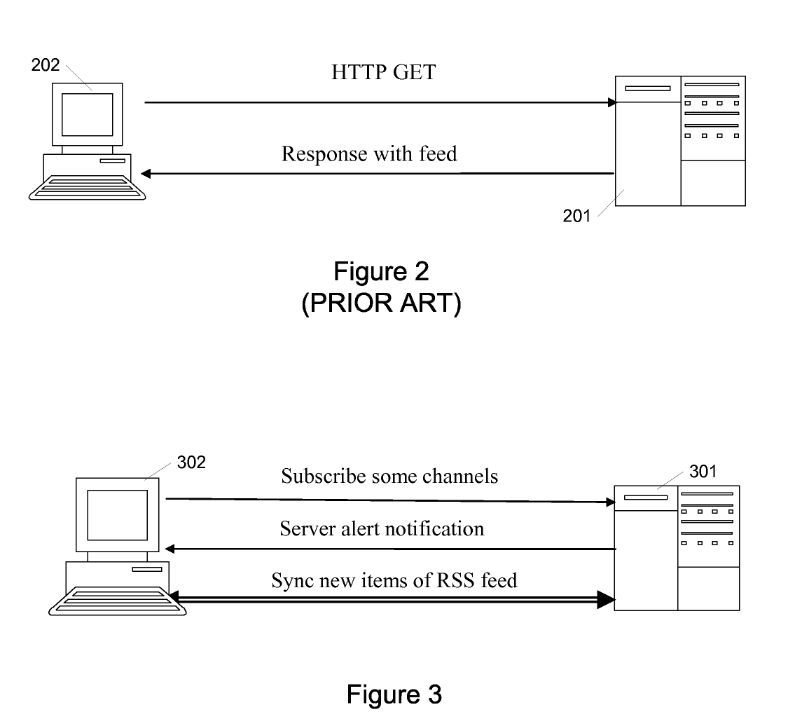

FIG. 2 illustrates a current system and associated process for transferring really simple syndication (RSS) feeds over a network. RSS feeds may be distributed from one or more RSS content servers such as server 201 to a subscriber, e.g., client device 202, using extensible markup language (XML) packets. RSS and other information feeds, as used herein, generally relate to a data format and publication method for serving frequently updated content such as news. Client device 202 may comprise a variety of systems including a PDA, computer, mobile communications device and the like. Client device 202 may further include memory storing a feed aggregator application and a processor for executing the application. Client device 202 may, using the aggregator, obtain RSS feeds by issuing feed request commands using hypertext transfer protocol (HTTP). In response to the feed requests, server 201 may transfer a current RSS feed to device 202. Generally, RSS feeds are transferred in their entirety. That is, the RSS feed typically includes both old and new data. Client device 202 may thus need to analyze the content of the RSS feed to identify and extract the new RSS items. In one example, device 202 may identify new RSS items by comparing the newly received RSS feed with an old locally stored version of the RSS feed.

The process of analyzing an RSS feed and identifying new content may require significant processing power from device 202. As such, if device 202 runs on battery power, the battery may be drained at a rate that reduces battery life significantly. Furthermore, new items might not be sent to client device 202 at the time they become available since client devices such as device 202 might only poll (i.e., request the RSS feed from) server 201 on a periodic basis. As such, RSS items such as news or stock quotes may become stale before client device 202 is scheduled to poll server 201 next. While increasing the polling rate may improve the currency of new RSS items, the increased polling rate may also waste bandwidth and increase costs. Still further, periodically transmitting an entire RSS feed (even when new content has not been added to the feed) may cause inefficiencies in the use of network bandwidth. These inefficiencies may further increase costs associated with network access, particularly in mobile communication networks where network access may be charged based on access time.

FIG. 3 illustrates another system for transferring RSS content using Open Mobile Alliance (OMA)-data synchronization (DS) protocol according to one aspect. OMA DS or synchronization markup language (SyncML) protocols provide an information synchronization standard that is generally platform-independent and allow streamlining of data synchronization processes. As such, OMA DS may be used to synchronize new RSS feed data on a server like server 301 with RSS information previously existing on a client device such as device 302. Initially, client device 302 may subscribe to one or more RSS feeds or channels using an RSS service provided by RSS server 301. Device 302 and server 301 may each comprise a PDA, laptop computer, cellular telephone (e.g., mobile terminal 112 of FIG. 1) and/or combinations thereof. Once subscribed, server 301 may detect when new RSS feed content is received or available using one or more detection modules. For example, server 301 may include one or more detection modules (not shown) that process RSS feed content to determine whether new feed item IDs are included in the latest feed. The one or more detection modules may comprise various types of hardware (processors, transceivers, etc.), software and the like. The components of the detection modules may be embodied in remote or local systems or both. A variety of other components may further be included in a detection module. The new content may then be synchronized between server 301 and device 302 without requiring the transmission of the entire RSS feed to which the new content belongs. Alternatively or additionally, a user may configure one or more RSS receiving preferences including frequency of updates and time of updates (e.g., only during the day or during a specific period of time).

Device 302 may communicate with server 301 through a variety of networks including wired and wireless communication networks. Each of device 302 and server 301 may include transmitters, receivers, transceivers and/or other communication components for facilitating communication processes. In one or more configurations, device 302 may also receive RSS feeds through an intermediate system (not shown) that may perform filtering and/or aggregation processes. For example, device 302 may use a web application to personalize RSS feed updates by filtering out information that is deemed uninteresting to a user of device 302. An intermediate system may further be used as a remote storage facility for storing RSS data until device 302 is able to receive the content. Alternatively or additionally, an intermediate system may facilitate the synchronization process with server 301, thus alleviating device 302 of the need to implement various aspects of the OMA DS protocol. Device 302 may further be configurable to switch between direct and indirect RSS feed reception from server 301.

According to one or more aspects, RSS server 301 may comprise an RSS feed service, allowing users to subscribe to various feeds through the service. As such, RSS server 301 may include a database (not shown) storing registered users of the RSS feed service. The table may further store user profiles as well as associations between the registered users and RSS feeds (i.e., channels) to which the users are subscribed. User profiles may be used to specify user preferences in receiving RSS feeds and updates from the service provided by server 301. The database may also store RSS feed information associated with each user and each subscribed channel. In particular, the database may store a synchronization status associated with each RSS feed or channel to which a user is subscribed. For example, the database may store an image of the RSS feed that currently exists on a user's device. This information may be used to determine whether updates are needed when new content is received by server 301.

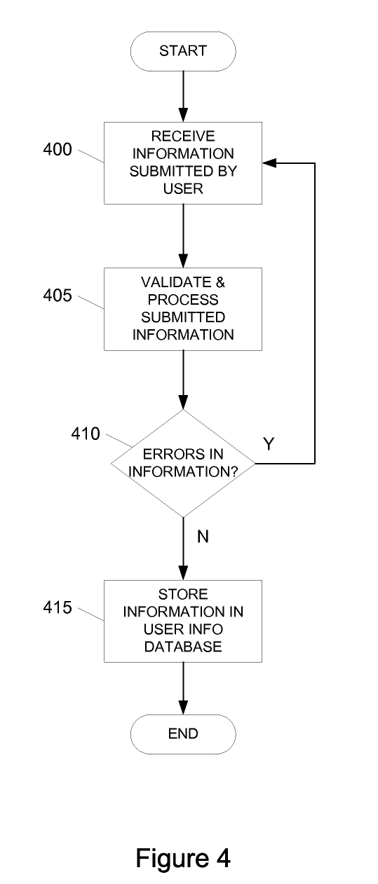

FIG. 4 is a flowchart illustrating a method by which a user may register with an RSS feed service. In step 400, a user may submit his or her information to an RSS server for registering with an RSS service. The submitted information may include a name, a telephone number, topics of interest, e-mail address and the like. In one or more configurations, a mobile telephone number may be required if the user wishes to receive RSS feeds on his or her mobile terminal. In step 405, the RSS server may process the submitted information by checking for sufficiency of the entered data, validating the information and formatting the data into a storage format. In one example, user information may be formatted into one or more records for storage in a user information table. Validation may include verifying that phone numbers are entered with the correct number of digits, that credit card numbers are valid and the like. If, in step 410, errors or inaccuracies are detected in the information, the user may be asked to resubmit the information for which an error was detected in step 400. If, however, it is determined in step 410 that no errors exist, the data may be stored to a database in step 415. Alternatively or additionally, the RSS server may further confirm the user's registration by sending a text message to the user's mobile terminal, transmitting an e-mail to a user's registered e-mail account and/or displaying a confirmation page once registration is completed.

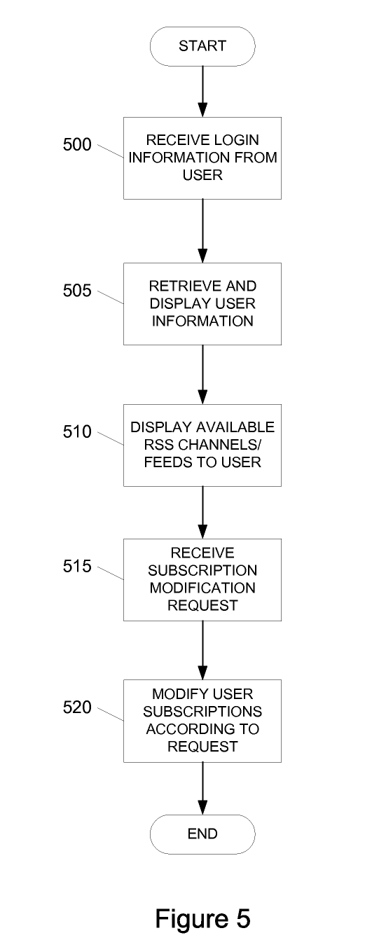

FIG. 5 is a flowchart illustrating a method for subscribing a user to one or more RSS feeds. In step 500, a user may log in to an RSS feed service after registering with the service according to, e.g., the registration method illustrated in FIG. 4. Alternatively or additionally, a user may be automatically logged in if he or she is connecting to the service through a private or trusted device. For example, a user's mobile telephone may store a cookie or security certificate that allows the user to automatically log in to the RSS feed service without entering his or her login information (e.g., username and password). Once the user has logged in to the service, information associated with the user may be retrieved and displayed in step 505. The information may include current channel subscriptions, user preference information, billing data and the like. The information may be retrieved from a database using identification information such as a username or a user ID number associated with the user. In step 510, a list of available feeds/channels may be displayed to the user. The RSS feed service might display only those channels to which the user is not currently subscribed. Alternatively, the service may display all channels with designations (e.g., visual indicators) for those channels to which the user is already subscribed. In step 515, the RSS feed service may receive a subscription modification request from a user. The request may specify channels to which the user wishes to subscribe and/or channels to which the user wishes to unsubscribe. In step 520, the requested subscription changes processed by updating a subscription database or table in association with the user. In one example, channels may be added to and/or deleted from a record corresponding to the user in a subscription table. Furthermore, in one or more arrangements, confirmation may be requested from the user prior to making the requested subscription modifications.

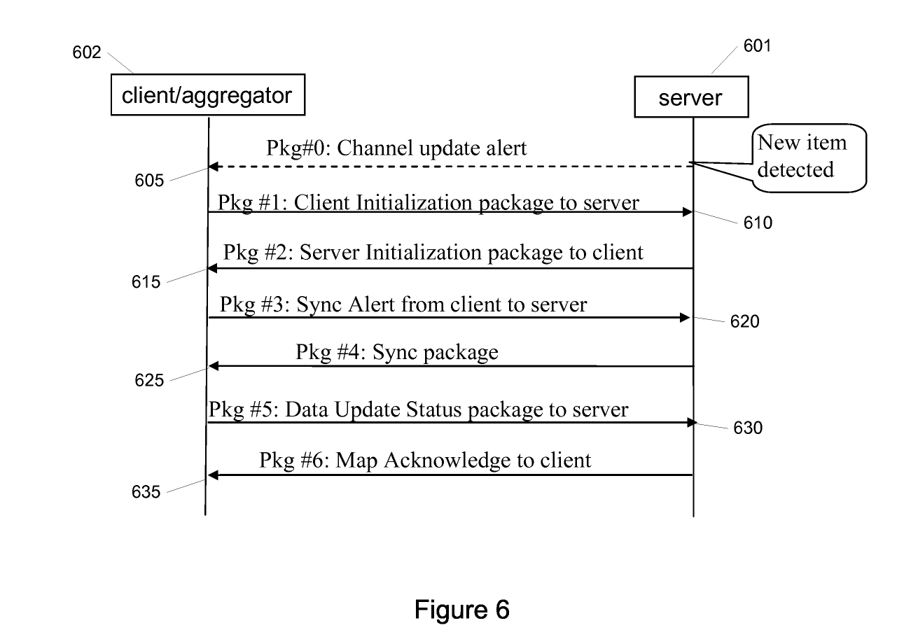

FIG. 6 illustrates a series of interactions between an RSS aggregator on a client device and an RSS content server for synchronizing a new RSS item. RSS aggregator system 602 may correspond to an application executing on a client device such as a mobile terminal or computing device. RSS content server 601, on the other hand, may comprise a remote server that hosts RSS feed services for one or more users and/or devices. Server 601 may store the RSS feed content itself or, alternatively or additionally, may retrieve content from one or more other content providers. RSS server 601 may monitor the RSS feeds to determine when new content becomes available. If new content becomes available, RSS server may send a data package (package #0) in step 605 to client/aggregator 602 alerting aggregator 602 of the new RSS item. The update alert package may include an identification of the channel in which the new item was received, a title of the new RSS item, a size of the item and other related information.

If aggregator 602 determines that a user is interested in the new item, aggregator 602 may send a client initialization package (package #1) to the server to establish a synchronization connection in step 610. In one or more arrangements, a device may prompt the user to determine whether the user wishes to retrieve the new item prior to issuing the client initialization package. An initialization package may be used to establish a synchronization connection. Additionally, initialization packages may further include information about each system's respective capabilities so that appropriate communication protocols may be established. For example, a client device might only be configured to receive data in a particular format. Knowing this capability information, a server may be able to appropriately configure data transmitted to the client device. Capability information may include database information, memory details and supported synchronization types. Authentication information may also be carried in the initialization package. In one example, a client's credentials may be authenticated by the server using Basic/MD5 authentication schemes upon receipt of the client initialization package. Further, the client initialization package may identify the synchronization type that is requested. Synchronization types may include two-way synchronization, one-way synchronization from client, one-way synchronization from server and the like. One-way synchronization refers to the synchronization of information in one direction (e.g., from the server to the client) while two-way synchronization provides synchronization in both directions (e.g., both the server and the client send each other their respective data). The server, in response to the client initialization package, may, in step 615, send a server initialization package (package #2) to the aggregator client establishing and confirming the synchronization connection.

Once the synchronization connection has been established and initialized, the aggregator client may then issue a synchronization alert (package #3) to the server in step 620. The synchronization alert may be used to identify, to the server, one or more RSS feeds or channels that require synchronization. The aggregator/client may determine which channels or feeds need synchronization based on the channel update alert received from the server in step 605. In response to the synchronization alert, the server may prepare and send a synchronization package (package #4) that includes the new item or items in the specified RSS feed or feeds to the client in step 625. In one or more configurations, the synchronization package (package #4) might not include old RSS feed items to limit the transfer size and bandwidth requirements. The synchronization package may include commands such as Add, Delete and Replace. Once the client has processed the synchronization package, e.g., by adding, deleting and/or replacing items in one or more RSS feeds, the client may then respond with a data update status package (package #5) in step 630. The data update status package may notify the server of the status of the synchronization package commands. Particularly, the data update status package may indicate whether each of the synchronization commands has been executed by the client. The data update status package may further include map commands for mapping client assigned IDs to server assigned IDs for the same items. If the data update status package does include map commands, the server may acknowledge the execution of those map commands in a subsequent map acknowledgment package (package #6) in step 635.

Mapping commands may be used so that client devices or systems may adopt their own independent identification schemes for feed items. Thus, should a client use their own client IDs to identify a feed item to a server, the server may be able to identify the appropriate feed item using the client ID/server ID mappings. Further, mapping may be performed by a mapping module associated with the server. The mapping module may include various hardware including one or more processors and/or receivers and software. The mapping module may create and store associations between client IDs and server IDs for the same feed item. Components of the mapping module may be included in the local server, on remote systems or both.

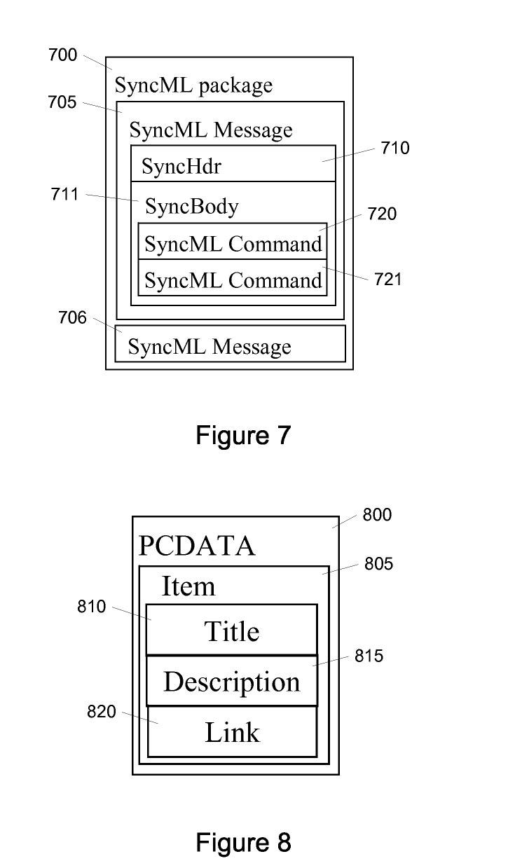

The packages and messages transmitted between the client and server in the synchronization process of FIG. 6 may be formatted according to OMA-DS/SyncML protocols. FIG. 7 illustrates one example of a SyncML package structure. Package 700 may include a plurality of synchronization messages 705 and 706. Each message 705 and 706 may further include a header, e.g., header 710 and a body, e.g., body 711. Header 710 may generally be used to specify routing, versioning and session information. Header 710 may also be used to store channel identification information for specifying the channel to which commands 720 and 721 stored in body 711 apply. Commands 720 and 721 may correspond to one or more synchronization commands such as Add, Copy, Delete, Replace and the like. Commands 720 and 721 may also each include data that is to be added, copied, deleted and/or replaced. For example, a new RSS feed item may be stored along with an Add command such as command 720. Package 700 may be expandable and scalable to accommodate data transfers of varying size.

FIG. 8 illustrates a command payload structure for a SyncML synchronization package such as package 700 (FIG. 7). In particular, payload 800 may be stored as a part of a SyncML command such as command 720 or 721 of FIG. 7. Payload 800 may include multiple items (e.g., news, stock quotes, etc.) such as item 805. Item 805 may include title 810 of item 805, description 815 and link 820. Title 810 may relate to a title associated with item 805 such as the title of a newspaper article or a stock symbol for a stock quote. Description 815 may store specifics associated with item 805 such as the body of a newspaper article, a stock value and the body of a message posted to a discussion forum. Link 820, on the other hand, may be used to identify a location where the item 805 may be found or accessed. For example, an article may be published on the World Wide Web (WWW) at a particular uniform resource location (URL) address. Accordingly, the URL associated with the article may be specified in link 820.

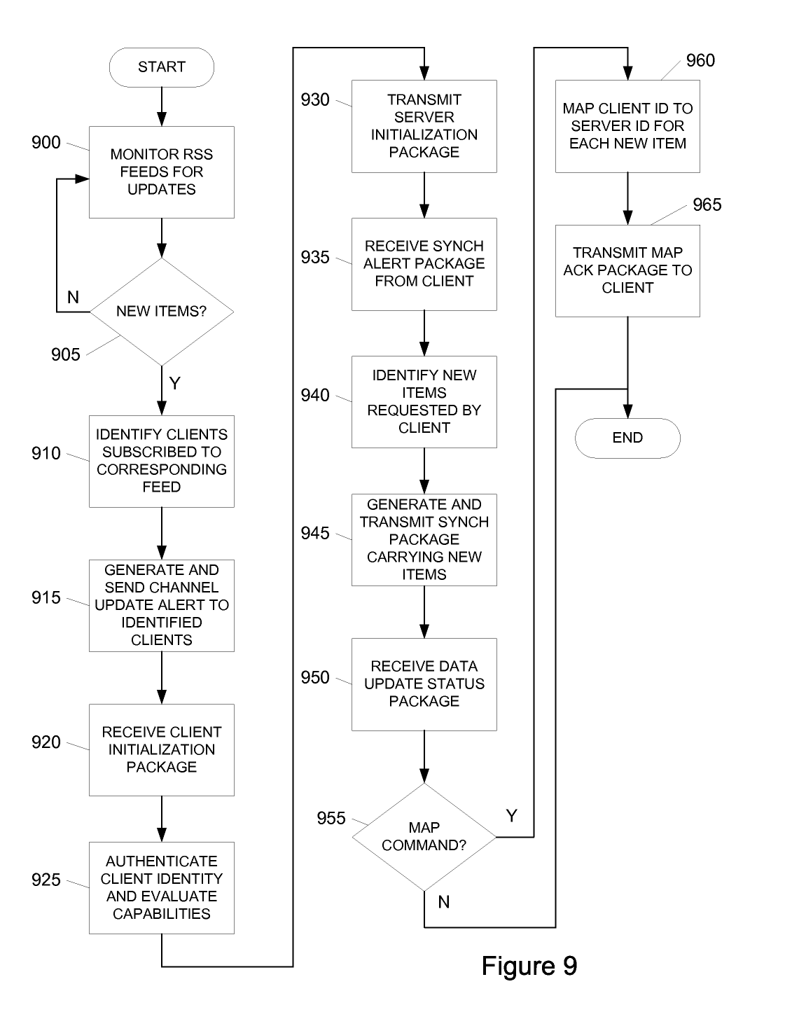

FIG. 9 is a flowchart illustrating the detection and synchronization of a new RSS item with a client device according to one or more variations. In step 900, an RSS server may monitor RSS feeds/channels for updates (e.g., using a detection or monitoring module). If, in step 905, the RSS server determines that an RSS feed has added a new item, the RSS server may identify one or more clients that are subscribed to the feed in step 910. In one or more arrangements, the RSS server may perform a lookup function on a subscription database to identify subscribing users. Further, an RSS server may determine that a new item has been added to a feed by comparing the new feed with an old or previously stored feed. Alternatively, an RSS server may examine a global ID assigned to the feed item to determine whether the feed item already exists on the server. Various other methods (e.g., used in RSS protocol) may also be used for determining whether new feed items have been added. In step 915, the RSS server may generate and send a channel update alert to each of the identified subscribed users. The alert may specify the channel that includes the new content item and other related information. In step 920, the RSS server may receive a client initialization package (e.g., SyncML package) from one or more of the subscribed users in response to the update alert message. Initialization packages, as discussed, may be used to identify a synchronization type, specify system capabilities and transmit authentication information. In response to the client initialization package, the server may authenticate the client to verify the client's identity and evaluate the client's capabilities in step 925. Once the client has been authenticated, the RSS server may then respond to the client initialization package with a server initialization package in step 930. Similar to the client initialization package, the server initialization package may include authentication information, synchronization anchors (i.e., for representing a synchronization event) and/or device information.

In step 935, the server may receive a synchronization alert package from a client device specifying one or more RSS feeds or channels for which synchronization is being requested. In response, the server may identify new items corresponding to the RSS feeds specified by the client in step 940. For example, the server may retrieve new items from an item table that stores new items that have not yet been synchronized with one or more clients. In step 945, the server may generate and transmit a synchronization package carrying the one or more new items to the client. The one or more new items may be transmitted to the client independently of previously transmitted RSS feed items. That is, the new items may be transmitted in a package that does not include previously transmitted RSS feed items. In addition, the synchronization package may include synchronization commands for processing the new items. For example, a synchronization package may specify that a new item should be added to the local RSS feed stored in the client device. In step 950, the server may receive a data update status package from the client indicating whether the synchronization commands have been processed. If, in step 955, the server determines that the data update status package includes a map command, the server may, in response, map the item IDs assigned by the client to the IDs assigned by the server for the same items in step 960. Mapping allows a client to use its own independent identification system rather than having to adopt the identification system of the server. Furthermore, in one or more configurations, a server may identify feed items not yet synchronized to the client by identifying feed items that do not have a client ID associated therewith. In step 965, the server may transmit a mapping acknowledgment to the client as confirmation that mapping was performed.

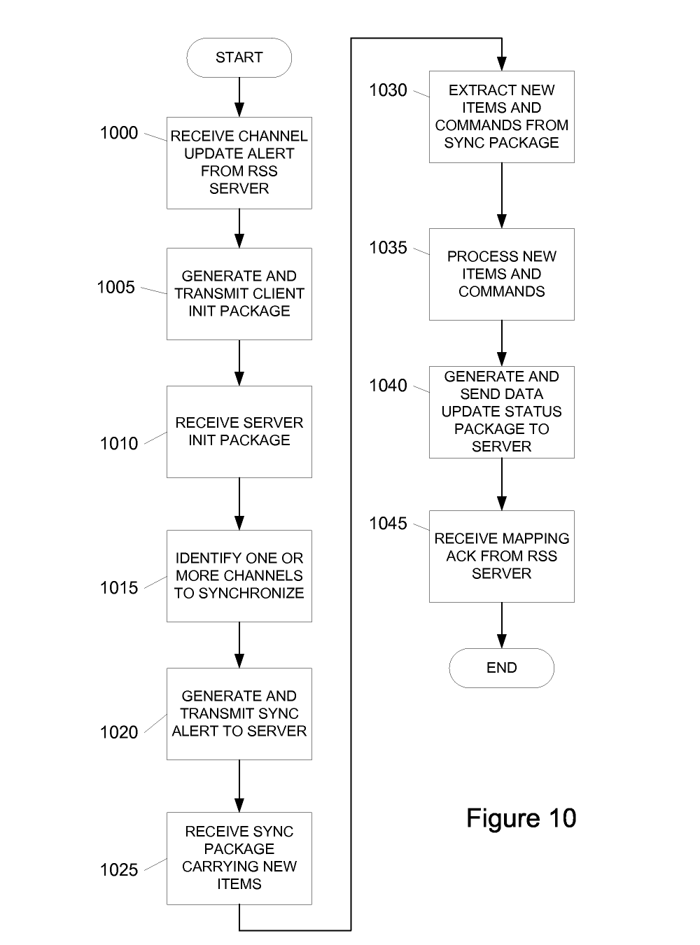

FIG. 10 is a flowchart illustrating a method for obtaining new RSS feed items through synchronization with an RSS server. In step 1000, a client may receive a channel update alert from an RSS service with which the client or user of the client is registered. In one or more arrangements, a user may make a manual determination as to whether new items corresponding to a channel update alert are to be downloaded. If the user does not wish to retrieve the new items, the channel update alert may be ignored. On the other hand, if the client determines that the new items should be retrieved, in step 1005, the client may generate and transmit a client initialization package to the server. The client initialization package may include, among other types of information, authentication information such as username, password, device ID and the like. In response to the client initialization package, the client may receive a server initialization package from the RSS server in step 1010. The server initialization package may also specify authentication information and other related synchronization data. Upon receiving the server initialization package, the client may determine one or more channels for which the client requires synchronization in step 1015. The client may make such a determination based on the channel update alert received in step 1000. Particularly, the client may determine that it requires synchronization of the channel or channels specified in the update alert. In step 1020, the client may then generate and transmit a synchronization alert to the server specifying the determined one or more channels for which synchronization is requested. In step 1025, the client may receive a synchronization package from the server carrying new items associated with the specified RSS feed or feeds. According to one or more aspects, the synchronization package might not include previously transmitted RSS feed items received by the client.

In step 1030, the client may extract the new items from the synchronization package in addition to the synchronization commands associated therewith. The client may then process the new items in accordance with the commands in step 1035. For example, if the synchronization command corresponds to an ADD command, the new item may be added to the client's local version of the RSS feed. In another example, if the command corresponds to a REPLACE command, the new item may be used to replace a previously existing item. According to one or more aspects, IDs may further be generated by the client for each new item stored to the client's database. Once the client has completed the synchronization process, the client may generate and send a data update status package to the server in step 1040. The data update status package may identify the commands that were successfully processed as well as provide commands and information for mapping a client ID with a server ID associated with each processed RSS item. In step 1045, the client may receive a server acknowledgment that mapping has been successfully performed.

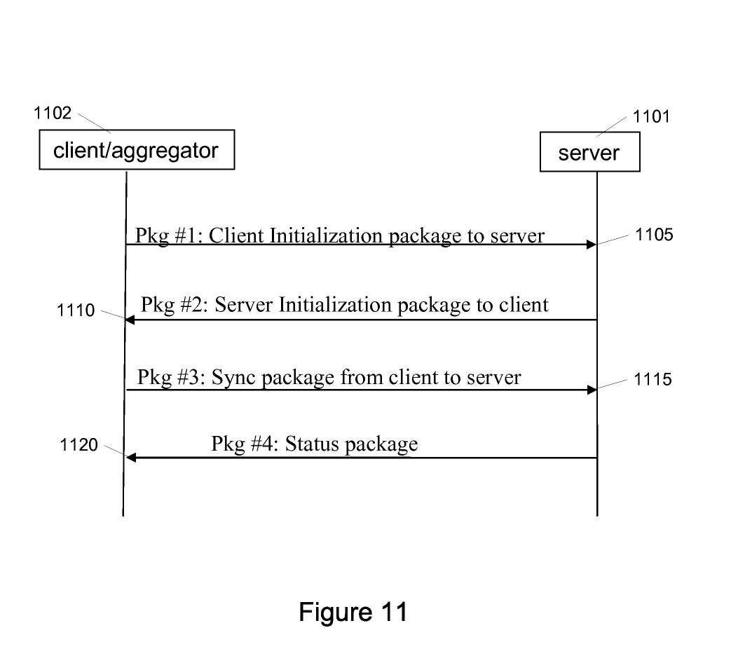

In one or more instances, a client may wish to publish new items to an RSS feed or channel. In such cases, the client may synchronize the client's RSS feed with that of the RSS server. For example, FIG. 11 illustrates a process by which server 1101 and client 1102 may synchronize a new item therebetween. Initially, client 1102 may send a client initialization package (package #1) to the server requesting synchronization in step 1105. Server 1101 may respond with a server initialization package (package #2) that acknowledges the request and provides various other information including authentication and capability information in step 1110. Subsequently, client 1102 may transmit a synchronization package (package #3) to server 1101 in step 1115. The synchronization package may have a structure similar to that described with respect to FIG. 7. For example, the synchronization package may include one or more synchronization commands that are to be executed by server 1101. Accordingly, in response to the synchronization package, server 1101 may perform the commands (e.g., add, replace, delete, etc.) included in the package and issue a status package (package #4) that notifies client 1102 of successful execution of the synchronization commands in step 1120. Alternatively or additionally, server 1101 may provide individual status information for each command in the event some commands were not executed while others were performed.

In one or more arrangements, a group or aggregation of feeds may be synchronized in a single synchronization session. That is, new feed items corresponding to different RSS or other information feeds may be updated and synchronized to a client in one synchronization session. Thus, multiple sessions need not be initialized between a client and a server to update different RSS feeds.

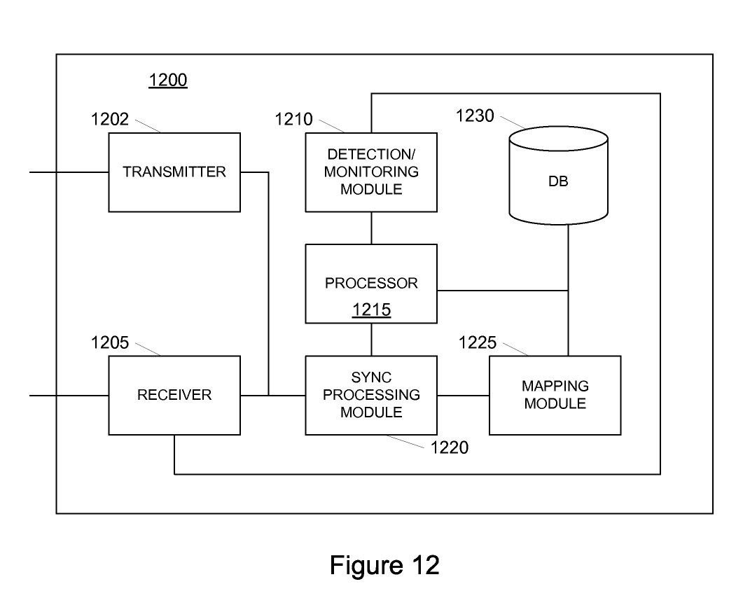

FIG. 12 illustrates a block diagram of a feed synchronization server for monitoring feeds and updating subscribing clients. Server 1200 may include a variety of components including transmitter 1202, receiver 1205, detection/monitoring module 1210, processor 1215, synchronization processing module 1220, mapping module 1225 and database 1230. Transmitter 1202 and receiver 1205 may facilitate communication over a variety of networks (e.g., wired and wireless) using varying types of network protocols (e.g., IP, BLUETOOTH, WLAN, etc.). Transmitter 1202 and receiver 1205, may, in one or more arrangements, be combined into a single transceiver. Detection/monitoring module 1210 may serve multiple purposes including monitoring information feeds for new feed items. Detection module 1210 may, for example, receive RSS feeds through receiver 1205 and compare the feeds with previous stored feeds or feed items in database 1230. If new feed items are received, module 1210 may alert relevant subscribers through synchronization module 1220. Synchronization module 1220 may be responsible for carrying out a variety of synchronization tasks including initializing synchronization sessions with one or more clients, processing synchronization requests and forwarding data to be synchronized to client devices.

In one or more configurations, module 1220 may further be linked to mapping module 1225 that may be used to perform mapping operations for synchronized feed items. In particular, mapping module 1225 may create and store associations between a client ID assigned to a feed item and a server ID assigned to the same feed item. Processor 1215 may be used to aid in processing a variety of data and/or instructions provided by one or more of modules 1220, 1225 and 1210. Modules 1210, 1220 and 1225 may comprise hardware, software or both for performing their tasks. In addition, modules 1210, 1220 and 1225 may include components that are distributed across both local systems (e.g., server 1200) and remote systems (not shown). Further, in one or more configurations, two or more of the server components (e.g., detection module 1210 and synchronization module 1220) may be combined into a single system or component (not shown). One of ordinary skill in the art will appreciate that various other types of components and modules may be included in a server system such as server 1200.

While messages and synchronization packages have been described with respect to OMA-DS (i.e., SyncML) format, one of ordinary skill in the art will appreciate that such OMA-DS messages and packages may be further encapsulated using other transmission protocols. For example, a SyncML message or package may be subsequently stored in an HTTP packet for transmission over the WWW. OMA-DS/SyncML packages may further be encapsulated using e-mail protocols, BLUETOOTH network encapsulation protocol (BNEP) and object exchange (OBEX) protocol. Furthermore, the features and methods described herein may be applied to other types of information feeds beyond RSS feeds. For example, synchronization may be used to updated other forms of web feeds.

Additionally, the methods and features recited herein may further be implemented through any number of computer readable mediums that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
detecting, by an information feed server, a new information feed item in an information feed;
sending a channel update alert to a client subscribed to the information feed, wherein the channel update alert indicates the detection of the new information feed item;
receiving a synchronization alert from the client requesting synchronization of the information feed; and
in response to the synchronization alert, transmitting a synchronization package including the new information feed item to the client but not previously-transmitted information feed items.

2. The method of claim 1 wherein the synchronization alert and the synchronization package are formatted according to an Open Mobile Alliance (OMA)-data synchronization (DS) protocol.

3. The method of claim 2, wherein the synchronization alert is further encapsulated in a Hypertext Transfer Protocol (HTTP) packet.

4. The method of claim 1, wherein the new information feed item comprises a new RSS feed item.

5. The method of claim 4, further comprising receiving a data update status message from the client, the data update status message including a mapping command for associating a client ID assigned by the client to the new RSS item with a server ID assigned to the new RSS item by the server.

6. The method of claim 1, wherein the synchronization package further includes one or more synchronization commands providing instructions for processing the new information feed item, the one or more synchronization commands including at least one of an add command, a delete command and a replace command.

7. The method of claim 1, wherein the client comprises a mobile communication device.

8. The method of claim 1, further comprising receiving a client initialization package from the client, wherein the client initialization package includes at least one of authentication information, capability information and synchronization type information.

9. The method of claim 1, further comprising retrieving, in response to the synchronization alert, the new information feed item from an item database.

10. A computer readable medium storing computer readable instructions that, when executed by a processor, cause the processor to perform a method comprising:
detecting, by an information feed server, a new information feed item in an information feed;
sending a channel update alert to a client subscribed to the information feed, wherein the channel update alert indicates the detection of the new information feed item;
receiving a synchronization alert from the client requesting synchronization of the information feed; and
in response to the synchronization alert, transmitting a synchronization package including the new information feed item to the client but not previously-transmitted information feed items.

11. The computer readable medium of claim 10, further comprising instructions for receiving a data update status message from the client, the data update status message including a mapping command for associating a client ID assigned by the client to the new information feed item to a server ID assigned by the server to the new information feed item.

12. The computer readable medium of claim 10, wherein the synchronization alert and the synchronization package are formatted according to an Open Mobile Alliance (OMA)-data synchronization (DS) protocol.

13. The computer readable medium of claim 10, wherein the information feed comprises an RSS feed.

14. A computer readable medium storing computer readable instructions that, when executed by a processor, cause the processor to perform a method comprising:
receiving, at a client, a channel update alert from an information feed server, wherein the channel update alert corresponds to an information feed to which the client is subscribed and wherein the channel update alert indicates an availability of a new information feed item;
transmitting a synchronization alert from the client to the server, the synchronization alert including a request for synchronization of the information feed; and
receiving a synchronization package from the server including the new information feed item but not previously received information feed items.

15. The computer readable medium of claim 14, wherein at least one of the channel update alert, synchronization alert and synchronization package is formatted in accordance with an Open Mobile Alliance (OMA)-data synchronization (DS) protocol.

16. The computer readable medium of claim 14, wherein the new information feed item comprises a new RSS feed item.

17. The computer readable medium of claim 14, wherein the client comprises a mobile communication device.

18. A computer readable medium storing computer readable instructions that, when executed by a processor, cause the processor to perform a method comprising:
transmitting, from the client, a client initialization package to an information feed server;
receiving, from the information feed server, a server initialization package for initializing a synchronization connection between the client and the information feed server;
transmitting a synchronization package to the information feed server, the synchronization package including a new information feed item and at least one synchronization command for updating an information feed to which the new information feed item corresponds; and
receiving, from the information feed server, a status package indicating an execution status of the at least one synchronization command.

19. The computer readable medium of claim 18 wherein at least one of the client initialization package, the server initialization package and the synchronization package is communicated in accordance with an Open Mobile Alliance (OMA)-data synchronization (DS) protocol.

20. The computer readable medium of claim 18 further comprising authenticating the server using authentication information received in the server initialization package.

21. The computer readable medium of claim 18, wherein the client comprises a mobile communication device.

22. An apparatus comprising:
means for detecting a new information feed item in an information feed;
means for sending a channel update alert to a client subscribed to the information feed, wherein the channel update alert indicates the detection of the new information feed item;
means for receiving a synchronization alert from the client requesting synchronization of the information feed; and
means for, in response to the synchronization alert, transmitting a synchronization package including the new information feed item to the client but not previously-transmitted information feed items.

23. The apparatus of claim 22 wherein the synchronization alert and the synchronization package are formatted according to an Open Mobile Alliance (OMA)-data synchronization (DS) protocol.

24. The apparatus of claim 23, wherein the synchronization alert is further encapsulated in a Hypertext Transfer Protocol (HTTP) packet.

25. The apparatus of claim 22, wherein the new information feed item comprises a new RSS feed item.

26. An apparatus comprising:
a processor; and
memory storing computer readable instructions that, when executed by the processor, cause the apparatus to perform a method comprising:
registering with an information feed service provided by a remote information feed server;
subscribing to an information feed available through the information feed service;
wirelessly receiving, from the remote information feed server corresponding to the subscribed information feed and wherein the channel update alert indicates the detection of a new information feed item added to the feed;
transmitting, to the information feed server, a synchronization alert including a request for synchronization of the information feed; and
in response to the alert, receiving a synchronization package from the remote RSS server including the new information feed item but not previously received feed items.

27. The apparatus of claim 26, wherein at least one of the channel update alert, synchronization alert and synchronization package is communicated in accordance with an Open Mobile Alliance (OMA)-data synchronization (DS) protocol.
